(19) United States
(12) Patent Application Publication
(10) Pub. No.: US 2025/0326274 A1
(43) Pub. Date: Oct. 23, 2025

(54) REAR AIR CONDITIONER FOR VEHICLES

(71) Applicants: Hyundai Motor Company, Seoul (KR); Kia Corporation, Seoul (KR)

(72) Inventors: Myung Hun KANG, Gwangmyeong-si (KR); Dong Won YEON, Hwaseong-si (KR); Sang Shin LEE, Suwon-si (KR); Bong Kyung SON, Ulsan (KR)

(21) Appl. No.: 18/953,430

(22) Filed: Nov. 20, 2024

(30) Foreign Application Priority Data
Apr. 22, 2024 (KR) 10-2024-0053328

(51) Int. Cl. B60H 1/24

(52) U.S. Cl. CPC B60H 1/244

(57) ABSTRACT

A rear air conditioner for a vehicle includes an air conditioning case, a blower disposed within the air conditioning case and connected to an inlet portion of the air conditioning case, a first passage defined between the blower and an internal side of a quad panel of the vehicle, a side vent-hole defined in the first passage and facing the quad panel, a bypass door configured to selectively open and close the first passage, a heat exchanger disposed between the bypass door and the side vent-hole, the heat exchanger being disposed in the first passage, a second passage defined between the blower an the outlet portion of the air conditioning case, and a controller configured to, based on external environment conditions of the vehicle in a cooling mode, (i) operate the bypass door to open the first passage and (ii) operate the heat exchanger.

### CROSS-REFERENCE TO RELATED APPLICATION

This application claims, under 35 U.S.C. § 119 (a), the benefit of and priority to Korean Patent Application No. 10-2024-0053328, filed on Apr. 22, 2024, the entire contents of which are incorporated herein by reference.

### TECHNICAL FIELD

The present disclosure relates to a rear air conditioner for a vehicle. In particular, to prevent condensation occurring in an electric vehicle, the present disclosure describes an air conditioner designed to prevent condensation on the quad panel by operating a portion of a heater to heat the air incoming through a blower and then allowing the air to flow into the quad panel.

### BACKGROUND

An electric vehicle may not generate exhaust heat, and condensation is likely to occur on the external side of a quad panel when an air conditioner is operated in a high temperature and humid environment.

In some examples, a rear air conditioner of an internal combustion engine vehicle may include several interconnected components, such as a duct, heat exchanger, blower, and discharge portion. These components are designed to work together to provide effective cooling or heating for rear seat passengers.

In some cases, the air conditioner for a vehicle may include both cooling and heating functions. For example, the air conditioner may selectively introduce outdoor or indoor air, cool or heat the air using an internal evaporator, internal condenser, and positive temperature coefficient (PTC) heater, and blow the same into the vehicle interior. The air conditioner may be used in an internal combustion engine vehicle and in an electric vehicle.

In some cases, when the air conditioner is operated in a cooling mode in an electric vehicle which neither has an engine nor generates exhaust heat, the temperature inside an external panel of the air conditioner decreases, which may result in condensation on the external side of the external panel in a high temperature and humid environment.

### SUMMARY

The present disclosure describes an air conditioner that prevents condensation on the external side of a quad panel. In some implementations, when operating in the cooling mode, a bypass door is operated by a controller to open a passage defined between a blower and an internal side of the quad panel. In some examples, air drawn in through the blower is heated using a portion of a heater included in a heat exchanger. The heated air is introduced into the quad panel through the passage, increasing the temperature inside the quad panel to prevent condensation.

The rear air conditioner for a vehicle to achieve the object of the present disclosure mentioned above has the following configuration.

According to one aspect of the subject matter described in this application, a rear air conditioner for a vehicle includes an air conditioning case including an inlet portion and an outlet portion, a blower connected to the inlet portion of the air conditioning case and disposed within the air conditioning case, a first passage defined between the blower and an internal side of a quad panel, a side vent-hole formed in the first passage and facing the quad panel, a bypass door configured to selectively open or close the first passage, a heat exchanger disposed between the bypass door and the side vent-hole, a second passage defined between the blower and the outlet portion, and a controller configured to operate the bypass door to open the first passage and to operate the heat exchanger disposed in the first passage, based on external environment conditions in the cooling mode.

In some implementations, the rear air conditioner may further include a first bypass door configured to open and close the first passage, and a second bypass door configured to open and close the side vent-hole.

In some implementations, the heat exchanger may include a partial regulating heater disposed in the first passage, an evaporator disposed in the second passage, and a heater disposed at a rear end of the evaporator and disposed in at least a portion of the second passage.

In some implementations, the controller may operate the partial regulating heater when the external environment conditions are satisfied.

In some implementations, the outlet portion of the air conditioning may include a roof duct disposed in the second passage, and an internal duct disposed in the second passage by being adjacent to the roof duct.

In some implementations, the outlet portion of the air conditioning may further include a mode door disposed in the second passage and configured to vary the opening amount of the internal duct and of the roof duct.

In some implementations, the heat exchanger may further include a mix door disposed adjacent to the heater and configured to be opened and closed to allow air that has passed through the evaporator to selectively bypass the heater.

In some implementations, regarding the external environment conditions, the controller may determine whether the outdoor temperature is equal to or greater than a predetermined temperature, whether the amount of solar radiation is equal to or smaller than a predetermined amount, whether the discharge temperature is equal to or smaller than a predetermined temperature, and whether the external relative humidity is equal to or greater than a predetermined humidity.

In some examples, when the external environment conditions are satisfied, the controller may operate the first bypass door and the second bypass door to open the first passage and to control the heat exchanger to heat air.

According to another aspect, a quad panel air supplier includes an air conditioning case including an inlet portion and an outlet portion, a blower connected to the inlet portion of the air conditioning case and disposed within the air conditioning case, a first passage defined between the blower and an internal side of a quad panel, a side vent-hole formed in the first passage and facing the quad panel, a bypass door configured to selectively open or close the first passage, a heat exchanger disposed between the bypass door and the side vent-hole, and a controller configured to operate the bypass door to open the first passage and to operate the heat exchanger disposed in the first passage, based on external environment conditions in the cooling mode.

In some implementations, the quad panel air supplier may further include a first bypass door configured to open the first passage, and a second bypass door configured to open and close the side vent-hole.

In some implementations, the heat exchanger may include a partial regulating heater disposed in the first passage.

In some implementations, regarding the external environment conditions, the controller may determine whether the outdoor temperature is equal to or greater than a predetermined temperature, whether the amount of solar radiation is equal to or smaller than a predetermined amount, whether the discharge temperature is equal to or smaller than a predetermined temperature, and whether the external relative humidity is equal to or greater than a predetermined humidity.

In some implementations, when the external environment conditions are satisfied, the controller may operate the first bypass door and the second bypass door to open the first passage and to control the heat exchanger to heat air.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure.

FIG. 1 is a perspective view illustrating an example of a rear air conditioner for a vehicle.

FIG. 2 is a cross-sectional view illustrating an example operating state of the rear air conditioner in the cooling mode.

FIG. 3 is a cross-sectional view illustrating the operating state of the rear air conditioner in a heating mode.

FIG. 4 illustrates an example state in which heated air is introduced into a quad panel.

FIG. 5 is a schematic flowchart for an example operation of the rear air conditioner in the cooling mode.

FIG. 6 is a detailed flowchart for an example operation of the rear air conditioner in the cooling mode.

In the figures, the reference numbers refer to the same or equivalent parts of the present disclosure throughout the several figures of the drawing.

### DETAILED DESCRIPTION

Hereinafter, one or more implementations of the present disclosure are described in detail with reference to the accompanying drawings. The implementations of the present disclosure may be modified into various forms, and the scope of the present disclosure should not be construed as being limited to the following implementations. The implementations are provided to more completely explain the present disclosure to those skilled in the art.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

A controller may be implemented as a memory that stores algorithms for controlling operation of various components placed in a vehicle or data on a program that reproduces algorithms and a processor that performs the above described operation using data stored in the memory. In some examples, the memory and the processor may be implemented as separate chips. Alternatively, the memory and the processor may be implemented as a single chip. For example, the controller may include at least one from an electronic control unit (ECU), a central processing unit (CPU), a microprocessor unit (MPU), a micro controller unit (MCU), an application processor (AP) or any type of processor well known in the art of the present disclosure.

For example, the application processor (AP) may be a processor configured to perform the function of controlling the rear air conditioner for a vehicle.

In some examples, the controller may be a combination of software and hardware capable of performing calculations for at least one application or program to execute a method according to the implementations of the present disclosure.

Hereinafter, one or more implementations will be described in detail with reference to the accompanying drawings, and in the description given with reference to the accompanying drawings, the same or corresponding components are assigned the same reference numerals, and a description thereof will not be repeated.

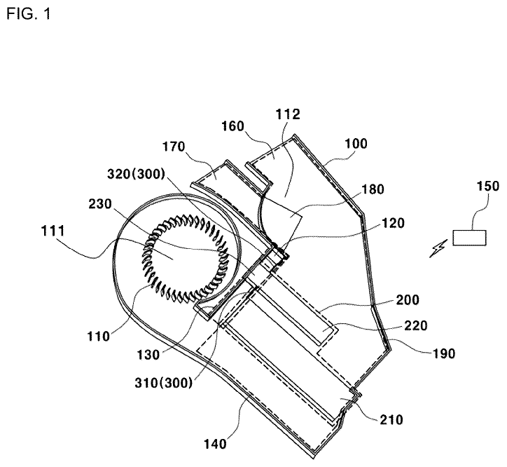

FIG. 1 is a perspective view illustrating a rear air conditioner for a vehicle according to the present disclosure.

In some implementations, the rear air conditioner for a vehicle may include an air conditioning case 100, a blower 110 disposed at an inlet portion 111 of the air conditioning case 100, and a heat exchanger 200 fluidly connected to the blower 110. The rear air conditioner may also include a mode door 180 configured to control the air outlet direction in cooling/heating mode, and a roof duct 160 and an internal duct 170 through which air drawn in is discharged. The rear air conditioner may further include, so as to prevent condensation on a quad panel 400 in the cooling mode, a first passage 130 defined between the blower 110 and the internal side of the quad panel 400, a bypass door 300 configured to open or close the first passage 130, and a second passage 140 defined between the blower 110 and an outlet portion 112 of the air conditioning case 100. The quad panel (400) is installed within the C-pillar of the vehicle, interacting with the rear air conditioning unit. Specifically, the quad panel is fixed to the inner wall of the C-pillar structure, helping to guide and control the airflow within the vehicle. The rear air conditioner may also include a side vent-hole 120 formed in the first passage 130 including at least a portion of a heater 220 and configured to fluidly connect the blower 110 to the internal side of the quad panel 400. The rear air conditioner may further include a mix door 190 disposed adjacent to the heater 220 and configured to mix air that has passed through the heater 220 with air that has not passed through the heater 220 among the air that has passed through an evaporator 210 by being selectively connected to a portion of the heater 220. Moreover, the rear air conditioner may include a mode door 180 disposed at the outlet portion 112 of the air conditioning case 100 and configured to selectively or simultaneously open the roof duct 160 and the internal duct 170 depending on cooling or heating mode. Furthermore, the rear air conditioner may include a controller 150 configured to, in the cooling mode, control the direction of the mode door 180 and of the mix door 190 depending on cooling/heating mode, to operate the bypass door 300 to open or close the first passage 130 by receiving external environment conditions, and to operate a partial regulating heater 230 to heat the air.

The rear air conditioner may be adopted in a large vehicle, such as a van or a recreational vehicle (RV) or a sport utility vehicle (SUV) whose interior volume is so large that the vehicle interior cannot be cooled or heated enough with only a front air conditioner. Moreover, the rear air conditioner may be installed usually in a closed space at the rear of the vehicle body to constitute a dual air conditioning system by being in conjunction with the front air conditioner.

The air conditioning case 100 includes the inlet portion 111 and the outlet portion 112 to allow outdoor air or indoor circulating air to flow in through the inlet portion 111 and to discharge cooled or heated air through the outlet portion 112.

The blower 110 disposed at the inlet portion 111 of the air conditioning case 100 may include an electric motor configured to operate a fan or impeller to circulate air in the air conditioner, and an impeller or wheel connected to the shaft of the electric motor and configured to draw air into the air conditioning system and push the air to the vents inside the system through various ducts.

Air drawn in through the blower 110 is discharged to the roof duct 160 or to the internal duct 170 through the second passage 140. In some examples, the temperature of the air increases or decreases through the heat exchanger 200. The heat exchanger 200 includes the evaporator 210 configured to decrease the temperature of the air drawn in, the heater 220 disposed in the second passage 140 and configured to increase the temperature of the air drawn in, and the partial regulating heater 230 disposed in the first passage 130. In some examples, to prevent condensation on the external side of the quad panel 400 in the cooling mode, the temperature of the air drawn in through the first passage 130 may be increased through the partial regulating heater 230.

The evaporator 210 may be disposed at a front end of the heater 220 to improve system efficiency. In some examples, when air is introduced into the interior of the vehicle, air introduced into the air conditioning case 100 is cooled first before being heated by the heater 220. The air may be cooled to a desired temperature before being heated, removing moisture in the air.

In the heating mode, air drawn in through the blower 110 is introduced into the second passage 140, passes through the evaporator 210, and then is heated by the heater 220, to thereby be increased in temperature. The heater 220 may be a positive temperature coefficient (PTC) heater. In some examples, the PTC heater 220 may be made of a material such as barium titanate, which has a positive temperature coefficient in which the amount of resistance increases as the temperature increases. Moreover, current flow may be limited by the electrical resistance increased when the temperature increases. In other words, when the temperature of the air flowing into the heater is low, current flows, but as the temperature increases, the flow of current is limited. Therefore, when the temperature is low, current flows through the PTC heater, and the temperature of the air increases due to the heat generated when the current flows.

In some examples, in the heating mode, the mix door 190 is operated by the controller 150, to thereby be rotated to be connected to a portion of the heater 220. The air that has passed through the evaporator 210 may entirely pass through the heater 220. Furthermore, in the heating mode, the mode door 180 is operated by the controller 150, to thereby be rotated in a direction to close the roof duct 160 and open the internal duct 170. Accordingly, the air whose temperature is increased after passing through the heater 220 is introduced into the internal duct 170.

In the cooling mode, air introduced into the air conditioning case 100 through the blower 110 is cooled through the evaporator 210. The evaporator 210 is connected to the vehicle's refrigerant circuit, and operates according to the phase change principle in which the refrigerant circulating through the evaporator 210 absorbs heat from indoor air and evaporates moisture from the air. The air passing through the evaporator 210 is condensed during heat exchange with the refrigerant circulating through the evaporator 210, loses moisture, and is simultaneously cooled to be decreased in temperature. The air cooled through the above process may be introduced into the heater 220.

In some examples, in the cooling mode, the mix door 190 is operated by the controller 150, to thereby be rotated to be selectively connected to a portion of the air conditioning case 100. The opening and closing amount of the mix door 190 may be adjusted to mix the air that has passed through the heater 220 with the air that has not passed through the heater 220 among the air cooled by passing through the evaporator 210. The air mixed by adjusting the opening and closing amount of the mix door 190 may be discharged to the roof duct 160. In some examples, in the cooling mode, the controller 150 receives external environment conditions and opens the bypass door 300 to open the first passage 130. In some examples, the controller 150 operates the partial regulating heater 230, and the air drawn in through the first passage 130 may be increased in temperature.

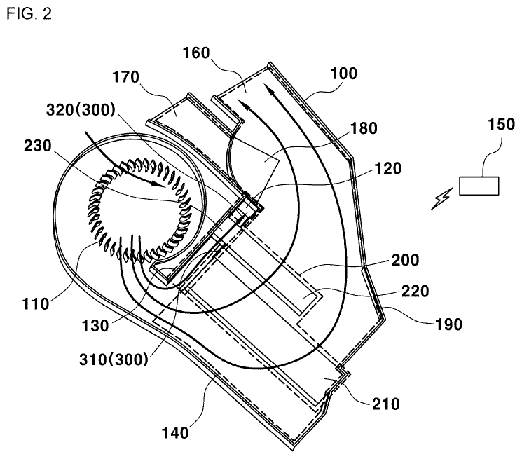

FIG. 2 is a view illustrating the operating state of the bypass door 300 and the partial regulating heater 230 in the cooling mode.

The bypass door 300 may include a first bypass door 310 configured to open and close the first passage 130 by being disposed adjacent to the partial regulating heater 230, and a second bypass door 320 configured to open and close the side vent-hole 120 by being disposed at the side vent-hole 120.

The first bypass door 310 moves in a direction to block the first passage 130 defined between the blower 110 and the internal side of the quad panel 400 when the heating mode or external environment conditions are not satisfied. In some examples, the second bypass door 320 moves in a direction to close the side vent-hole 120.

In some examples, when the external environment conditions are satisfied in the cooling mode, the first bypass door 310 moves in a direction to open the first passage 130 and the second bypass door 320 moves in a direction to open the side vent-hole 120. In some examples, the air introduced into the air conditioning case 100 through the blower 110 is partially discharged to the internal surface of the quad panel 400. At this time, the temperature of the air drawn in is increased through the partial regulating heater 230 disposed in the first passage 130. In some examples, the partial regulating heater 230 may be a PTC heater. The resistance value of the partial regulating heater 230, which is a PTC heater, decreases when the temperature of the incoming air decreases, and the flow of the current applied into the heater 220 increases than before, thereby generating high heat. Accordingly, the air passing through the partial regulating heater 230 may be increased in temperature and flow into the quad panel 400 through the first passage 130.

Furthermore, a portion of the air drawn in through the blower 110 is introduced into the evaporator 210 through the second passage 140. The air introduced into the evaporator 210 loses moisture through heat exchange in the evaporator 210 and is decreased in temperature. The air whose temperature is decreased is discharged to the roof duct 160 through the second passage 140. In some examples, in the cooling mode, the opening and closing amount of the mix door 190 may be adjusted by the mix door 190 rotating to a side of the air conditioning case 100 to mix the air that has passed through the heater 220 with the air that has not passed through the heater 220 among a portion of the air that has passed through the evaporator 210. Furthermore, the mode door 180 is moved to a direction to close the internal duct 170, and the air cooled by the internal duct 170 being closed is discharged to the interior of the vehicle through the roof duct 160.

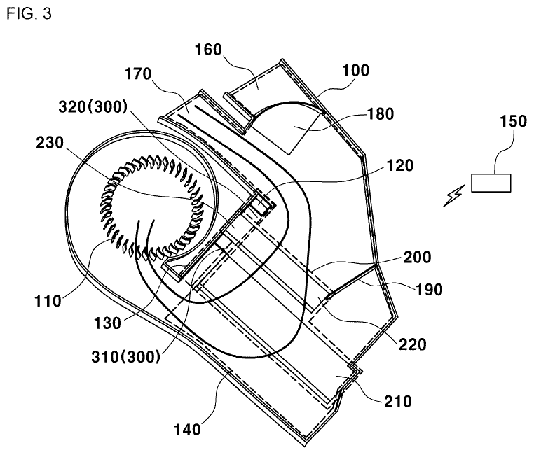

FIG. 3 is a view illustrating the air flow in the heating mode. In the heating mode, the first bypass door 310 is moved to a direction to block the first passage 130, and the second bypass door 320 is moved to a direction to block the side vent-hole 120. With this process, the first passage 130 is blocked.

Moreover, air introduced into the air conditioning case 100 through the blower 110 is introduced into the second passage 140, and then passes through the evaporator 210 and the heater 220 disposed in the second passage 140, to thereby be discharged to the internal duct 170. In some examples, in the heating mode, the mix door 190 may rotate in a direction to be connected to a portion of the heater 220. Thereafter, the entire air that has passed through the evaporator 210 passes through the heater 220 to thereby be increased in temperature. Furthermore, the mode door 180 is moved in a direction to close the roof duct 160 to block the roof duct 160. In some examples, the air whose temperature is increased is discharged to the interior of the vehicle through the internal duct 170.

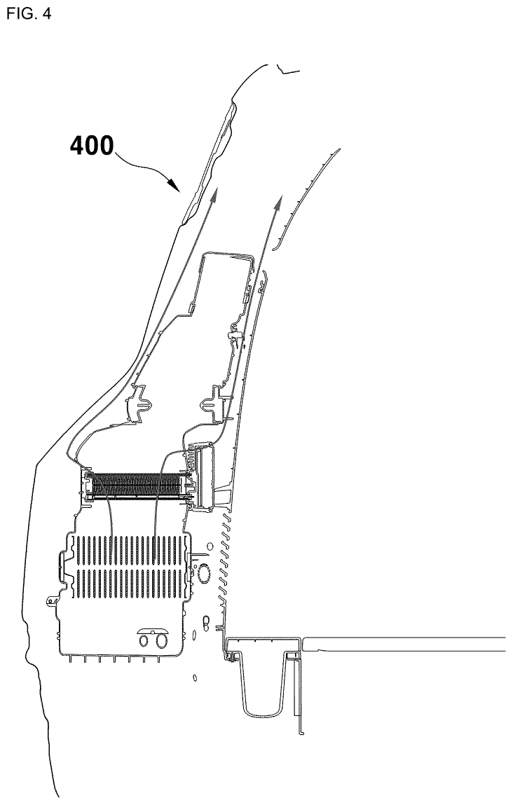

FIG. 4 is a rear cross-sectional view of the quad panel 400, wherein the heated air is introduced into the quad panel 400.

Condensation on the external surface of the quad panel 400 occurs when the temperature of the air containing moisture decreases at or below the dew point and the moisture contained in the air condenses to become water droplets on the surface of an object. In other words, condensation on the external surface of the quad panel 400 occurs when water vapor contained in the air condenses by being brought into contact with the surface of an object having a relatively low temperature. Moreover, condensation is affected by various factors, such as the concentration and temperature of the water vapor, atmospheric pressure, temperature of the object's surface, and relative humidity.

So as to prevent condensation, according to the present disclosure, a portion of the air drawn in through the blower 110 is heated to a predetermined temperature, and the heated air is introduced into the quad panel 400. When the external environment conditions are satisfied in the cooling mode, the first passage 130 is opened by the bypass door 300, and the air whose temperature is increased through the first passage 130 is introduced into the quad panel 400. The temperature inside the quad panel 400 is increased by the air introduced thereinto. When the temperature inside the quad panel 400 increases, the temperature at the external side of the quad panel 400 also increases. Accordingly, the difference between the outdoor temperature and the temperature at the external side of the quad panel 400 decreases. In some examples, the dew point increases, preventing condensation on the external surface of the quad panel 400.

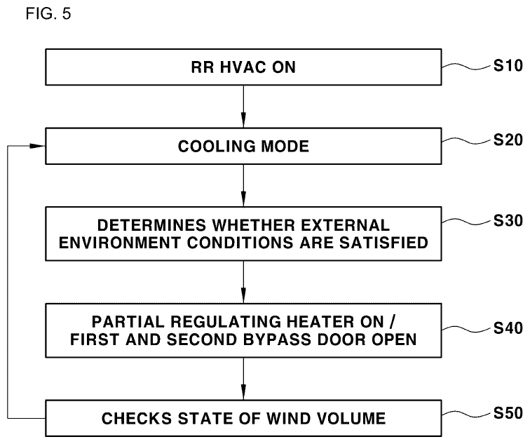

FIG. 5 is a schematic flowchart of the present disclosure to prevent condensation. A series of processes can be performed in order to operate the present disclosure. For example, when the rear air conditioner starts operating at step S10, the controller 150 determines whether the rear air conditioner operates in the cooling mode at step S20. Thereafter, the controller 150 determines whether the rear air conditioner satisfies the external environment conditions at step S30. When satisfying the external environment conditions, the controller 150 operates the partial regulating heater 230 and opens the first bypass door 310 and the second bypass door 320 at step S40. The controller 150 also checks the state of wind volume to prevent temperature decrease in the quad panel 400 at step S50. Furthermore, the controller 150 may continuously provide air into the quad panel 400 through feedback control.

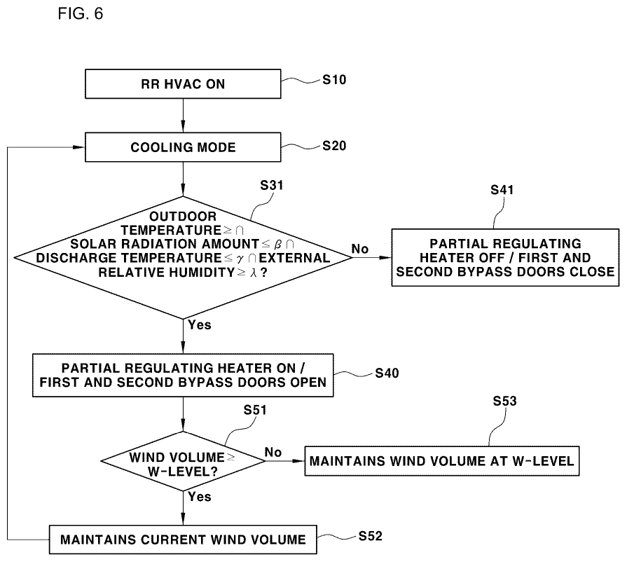

FIG. 6 is a detailed flowchart for the operation of the condensation prevention system in the cooling mode.

When the rear air conditioner starts operating at step S10, the controller 150 first checks whether the rear air conditioner operates in the cooling mode at step S20. When the rear air conditioner is determined to operate in the cooling mode, the controller 150 receives the external environment conditions to determine whether the external environment conditions are satisfied at step S30. When the external environment conditions are satisfied, the controller 150 may form the first passage 130 and operate the partial regulating heater 230 to heat the air introduced through the first passage 130. More specifically, in determining whether the external environment conditions are satisfied, the controller 150 may determine whether the outdoor temperature is equal to or greater than a predetermined temperature, whether the amount of solar radiation is equal to or smaller than a predetermined amount, whether the discharge temperature is equal to or smaller than a predetermined temperature, whether the external relative humidity is equal to or greater than a predetermined humidity at step S31. Factors for the information value of the external environment may be received through an auto defog sensor (ADS), outdoor temperature sensor, photo sensor, GPS, weather, duct sensor, etc.

In some examples, the information value of the outside temperature may be calculated by receiving weather information from the outside temperature sensor, the information value of the amount of solar radiation may be calculated by receiving weather information from the photo sensor, and the information value of the amount of solar radiation and external relative humidity may be calculated by receiving weather information on the current location through GPS from the auto defog sensor (ADS) or an info system. The information value of the discharge temperature may be received from the temperature sensor attached to the duct. When the external environment conditions are not satisfied, the controller 150 stops the operation of the partial regulating heater 230, moves the first bypass door 310 in a direction to block the first passage 130, and moves the second bypass door 320 in a direction to close the side vent-hole 120 at step S41.

In some examples, when the external environment conditions are satisfied, the controller 150 opens the first bypass door in a direction to open the first passage 130, and opens the second bypass door in a direction to open the side vent-hole 120. Moreover, the controller 150 operates the partial regulating heater 230 to increase the temperature of the air flowing in through the first passage 130 at step S40. Thereafter, the controller 150 determines whether the wind volume is equal to or greater than a set value to prevent temperature decrease in the quad panel 400 at step S51.

When the wind volume is smaller than the set value, the wind volume is regulated to the set value at step S52. When the wind volume is equal to or greater than the set value, the wind volume is kept in the current state at step S53. When the wind volume is regulated to the set value or kept in the current state, the controller 150 may perform feedback control in the cooling mode to repeat the above process.

The present disclosure is to prevent condensation on the external side of the quad panel, and as is apparent from the above description, the following effects may be obtained by the configuration, combination, and use relationship described above.

In some examples, corrosion caused by external condensation may be prevented.

In some examples, aesthetic damage, such as stains or stripes which may be caused by condensation continually occurring on the exterior panel, may be prevented, preventing damage to the exterior of the vehicle.

In some examples, corrosion and aesthetic damage caused by external condensation may be prevented, minimizing maintenance efforts and related costs.

The detailed description is merely illustrative of the present disclosure. In addition, the above description shows and describes implementations of the present disclosure, but the present disclosure can be used in various other combinations, modifications, and environments. In other words, changes or modifications are possible within the scope of the idea of the invention disclosed herein, the scope of equivalents to the described invention, and/or the scope of skill or knowledge in the art. The implementations describe the best state for implementing the technical idea of the present disclosure, and various changes for specific application fields and uses of the present disclosure are possible. Therefore, the detailed description of the present disclosure is not intended to limit the present disclosure to the disclosed implementations. Also, the appended claims should be construed to include other implementations.

What is claimed is:

1. A rear air conditioner for a vehicle, the rear air conditioner comprising:
an air conditioning case comprising an inlet portion and an outlet portion;
a blower disposed within the air conditioning case and connected to the inlet portion of the air conditioning case;
a first passage defined between the blower and an internal side of a quad panel located in C-pillar of the vehicle;
a side vent-hole defined in the first passage, the side vent-hole facing the quad panel;
at least one bypass door configured to selectively open and close the first passage;
a heat exchanger disposed between the at least one bypass door and the side vent-hole, the heat exchanger being disposed in the first passage;
a second passage defined between the blower and the outlet portion of the air conditioning case; and
a controller configured to, in a cooling mode, (i) operate the at least one bypass door to open the first passage and (ii) operate the heat exchanger based on external environment conditions.

2. The rear air conditioner of claim 1, wherein the at least one bypass door comprises:
a first bypass door configured to open and close the first passage; and
a second bypass door configured to open and close the side vent-hole.

3. The rear air conditioner of claim 1, wherein the heat exchanger comprises:
a partial regulating heater disposed in the first passage;
an evaporator disposed in the second passage; and
a heater disposed at a rear end of the evaporator, the heater being disposed in at least a portion of the second passage.

4. The rear air conditioner of claim 3, wherein the controller is configured to operate the partial regulating heater based on the external environment conditions being satisfied.

5. The rear air conditioner of claim 1, wherein the outlet portion of the air conditioning case comprises:
a roof duct disposed in the second passage; and
an internal duct disposed in the second passage, the internal duct being disposed adjacent to the roof duct.

6. The rear air conditioner of claim 5, further comprising a mode door disposed in the second passage and configured to vary an opening amount of the internal duct and an opening amount of the roof duct.

7. The rear air conditioner of claim 3, further comprising a mix door disposed adjacent to the heater and configured to open and close to thereby cause air that has passed through the evaporator to selectively bypass the heater.

8. The rear air conditioner of claim 2, wherein the external environment conditions comprise an outdoor temperature of the vehicle, an amount of solar radiation, a discharge temperature detected at the outlet portion, and an external relative humidity, and
wherein the controller is configured to:
determine whether the outdoor temperature is greater than or equal to a predetermined temperature,
determine whether the amount of solar radiation is less than or equal to a predetermined amount,
determine whether the discharge temperature is less than or equal to a preset temperature, and
determine whether the external relative humidity is greater than or equal to a predetermined humidity.

9. The rear air conditioner of claim 8, wherein the controller is configured to, based on the external environment conditions being satisfied, (i) operate the first bypass door and the second bypass door to open the first passage and (ii) control the heat exchanger to heat air.

10. A quad panel air supplier, comprising:
an air conditioning case comprising an inlet portion and an outlet portion;
a blower disposed within the air conditioning case and connected to the inlet portion of the air conditioning case;
a first passage defined between the blower and an internal side of a quad panel of a vehicle;
a side vent-hole defined in the first passage, the side vent-hole facing the quad panel;
at least one bypass door configured to selectively open and close the first passage;
a heat exchanger disposed between the bypass door and the side vent-hole, the heat exchanger being disposed in the first passage; and
a controller configured to, in a cooling mode, (i) operate the at least one bypass door to open the first passage and (ii) operate the heat exchanger based on external environment conditions.

11. The quad panel air supplier of claim 10, wherein the at least one bypass door comprises:
a first bypass door configured to open and close the first passage; and
a second bypass door configured to open and close the side vent-hole.

12. The quad panel air supplier of claim 11, wherein the heat exchanger comprises a partial regulating heater disposed in the first passage.

13. The quad panel air supplier of claim 11, wherein the external environment conditions comprises an outdoor temperature of the vehicle, an amount of solar radiation, a discharge temperature detected at the outlet portion, and an external relative humidity, and
wherein the controller is configured to:
determine whether the outdoor temperature is greater than or equal to a predetermined temperature,
determine whether the amount of solar radiation is less than or equal to a predetermined amount,
determine whether the discharge temperature is less than or equal to a preset temperature, and
determine whether the external relative humidity is greater than or equal to a predetermined humidity.

14. The quad panel air supplier of claim 13, wherein the controller is configured to, based on the external environment conditions being satisfied, (i) operate the first bypass door and the second bypass door to open the first passage and (ii) control the heat exchanger to heat air.
